(19) United States
(12) Patent Application Publication
(10) Pub. No.: US 2014/0187705 A1
(43) Pub. Date: Jul. 3, 2014

(54) ADHESIVES

(71) Applicants: Evelyn Peiffer, Leverkusen (DE); Mathias Matner, Neuss (DE)

(72) Inventors: Evelyn Peiffer, Leverkusen (DE); Mathias Matner, Neuss (DE)

(73) Assignee: Bayer Intellectual Property GmbH, Monheim (DE)

(21) Appl. No.: 14/124,448

(22) PCT Filed: Jun. 5, 2012
(86) PCT No.: PCT/EP2012/060587

§ 371 Date: Jan. 29, 2014

(30) Foreign Application Priority Data
Jun. 8, 2011 (DE) 10 2011 077 200.6

(51) Int. Cl. C09J 175/08

(52) U.S. Cl. CPC C09J 175/08
USPC 524/507; 525/102; 525/458

(57) ABSTRACT

The present invention relates to adhesives based on silane-modified polymers and to substrates coated therewith and connected thereto.

### ADHESIVES

Adhesives based on organic polymers have found widespread use in daily life. In many cases in the production of adhesives, the organic binders are mixed with fillers (external fillers, e.g. chalk) in order to reduce the material costs of the adhesive. This addition of fillers has either no adverse effect or a tolerable adverse effect on the mechanical properties of the adhesive. In many cases the addition of so-called reinforcing fillers, such as precipitated chalks, carbon blacks or fibres, has a beneficial effect on the mechanical properties.

However, the addition of external fillers also has associated disadvantages. Thus, in the case of moisture-reactive polymers, the fillers have to be dried before they are added, so as not to cause a premature reaction of the binder. The fillers can also lead to difficulties on application (high viscosity, abrasion) and storage (sedimentation of the fillers).

In the case of silane-terminated polymers, however, the addition of external fillers is essential because, without fillers, these binders exhibit only a very weak cohesion. It is therefore preferable to use reinforcing fillers, such as precipitated chalks or finely divided carbon blacks, in the formulation of corresponding adhesives. As silane-terminated polymers are moisture-reactive systems, the fillers have to be carefully predried in order to achieve the desired storability of the adhesive. This necessitates correspondingly laborious, cost-intensive and energy-intensive formulation processes.

Surprisingly, it has now been found that silane-terminated polymers comprising dispersed organic polymers have a high cohesive strength even without the addition of external fillers of the type described above. These silane-terminated polymers can thus be formulated in a very simple process and nevertheless give storage-stable adhesives of adequate strength.

Silane-terminated polymers as binders for adhesives and sealants have been known for many years. The principles of their formulation are described e.g. in “Formulierung von Kleb- und Dichtstoffen”, Bodo Müller/Walter Rath, Vincentz Network, 2004, pp 276-279. DE-A 69 233 460 also describes the use of the typical chalks coated with fatty acids as fillers in the formulation of silane-terminated polymers.

EP-A 0 538 880 lists a whole series of organic and inorganic fillers which are incorporated into the polymer during formulation.

EP-A 1 457 527 describes the use of special silicates with which the weather resistance and combustion properties of adhesives can be improved.

Acicular fillers are used in EP-A 1 702 958 to adjust the rheology of adhesives.

Hollow spheres of polyvinylidene chloride are described in EP-A 0 520 426. These are said to reduce the specific density of the formulation and are used especially when the products are sold on a volume basis.

EP-A 1 957 553 (corresponding to WO 2007/054300) uses silicic acids of relatively small specific surface area as fillers to improve the mechanical properties of adhesives. EP-A 2 016 134 (corresponding to WO 2007/131912) describes transparent compounds in which exclusively pyrogenic silicic acids are used as fillers. However, the resulting mechanical properties only permit their use as sealants or flexible adhesives.

However, a common feature of all these described formulations is the fact that the fillers used may only have a very low water content so as not to limit the storage stability of the adhesive. A physical or chemical drying of the fillers is therefore imperative. Furthermore, mixing of the binders with the fillers is not a trivial operation and involves quite a large expenditure on apparatuses, is time-intensive and thus restricts the capacity of the plant. The object of the present invention was therefore to develop adhesives based on silane-terminated polymers whose preparation can dispense with the addition of external fillers.

Surprisingly, this object could be achieved by using, as binders for the adhesives, silane-terminated polymers in which another organic polymer is dispersed.

The invention therefore provides moisture-curing adhesives comprising
a) at least one polymer A with at least one hydrolysable silane group and with at least one organic polymer B dispersed in the polymer A,
b) optionally other polymers with at least one hydrolysable silane group, and
c) optionally additives and auxiliary substances.

The preparation of polymers A with at least one hydrolysable silane group is known in principle. Various processes are described in the literature. Examples which may be mentioned here are DE-A 2 837 074 for the hydrosilylation of a polymer with terminal double bonds, DE-A 1 745 526 for the bonding of organosilicon compounds with an isocyanate-reactive group on to NCO-containing polymers, and U.S. Pat. No. 4,146,585 for the reaction of isocyanate-functional organosilicon compounds with OH-functional polymers.

Thus the polymers A according to the invention can be e.g. polyethers, polyurethanes (based on polyethers and/or polyesters and/or polycarbonate polyols), polyesters, polycarbonates, polysiloxanes, polyureas, polyacrylates, polyamides, polystyrenes or polyolefins, each having at least one hydrolysable silane group. Of course, it is also possible to use any desired mixtures or combinations of the various polymers.

Examples of raw materials which can be used for polymers A are the polyols known from foam production which are described in EP-A 1 505 082, EP-A 0 008 444, U.S. Pat. No. 4,089,835 or U.S. Pat. No. B 7,179,882.

However, the invention is not limited to such systems, but encompasses all polymers A comprising another polymer B which is dispersed in A in such a way that there is no sedimentation of B in A.

The adhesives according to the invention comprise at least 5 wt % of polymer A, preferably at least 10 wt % and particularly preferably at least 20 wt % of polymer A.

The adhesives according to the invention do not comprise any external fillers.

The adhesives according to the invention normally have tensile strengths of at least 5 N/mm², preferably of at least 6 N/mm² and particularly preferably of at least 7 N/mm². The tensile strength is determined by the method described in the experimental section.

The adhesives according to the invention comprise at least 5 wt % of polymer B, preferably at least 10 wt % and particularly preferably at least 15 wt % of polymer B.

Examples of suitable polymers B are styrene-acrylonitrile copolymers (SAN), poly-hydrazodicarbonamide polymers (PHD), polyisocyanate polyaddition polymers (PIPA), polyacrylates or polyvinyl polymers, it being preferable according to the invention to use styrene-acrylonitrile copolymers (SAN) or polyhydrazodicarbonamide polymers (PHD) as polymers B.

Particularly suitable polymers B according to the invention are those where the polymer B is stably dispersed in the polymer A (i.e. it has no tendency to sediment). For example, such dispersions can be produced by preparing the polymer B, e.g. SAN, in the OH compound used to prepare the silane-terminated polymer A (e.g. a polyether polyol or polyester polyol). In this process, molecules of the OH compound are grafted on to the forming particles of the polymer B to a small but sufficient extent to produce a stable dispersion of the polymer B in the OH compound. These graft branches afford a mutual compatibility between the two substances in a similar way to emulsifier molecules in the production of stable dispersions of lipophilic substances in water. Finally, either this dispersion is silane-terminated directly by reaction of the OH compound with isocyanatosilane, or the OH groups are first reacted with a polyisocyanate, optionally under chain extension, and then silane-terminated with an aminosilane to give the polymer A.

To prepare such adhesives, the polymers according to the invention having alkoxysilane end groups can be formulated by known processes together with conventional solvents, plasticizers, pigments, desiccants, additives, light stabilizers, antioxidants, thixotropic agents, catalysts, adhesion promoters and optionally other auxiliary substances and additives.

Typical adhesive formulations according to the invention comprise e.g. 5 wt % to 100 wt % of a polymer A according to claim 1 or a mixture of two or more such polymers modified with alkoxysilane groups, up to 95% of another polymer with at least one hydrolysable silane group, up to 50 wt % of a plasticizer or a mixture of two or more plasticizers, up to 50 wt % of a solvent or a mixture of two or more solvents, up to 20 wt % of a moisture stabilizer or a mixture of two or more moisture stabilizers, up to 5 wt % of an ageing stabilizer or a mixture of two or more ageing stabilizers, up to 10 wt % of an adhesion promoter or a mixture of two or more adhesion promoters, up to 5 wt % of a catalyst or a mixture of two or more catalysts, and up to 30 wt % of a thixotropic agent or a mixture of two or more thixotropic agents.

Examples of suitable plasticizers which may be mentioned are phthalic acid esters, adipic acid esters, alkylsulfonic acid esters of phenol, phosphoric acid esters or higher-molecular polypropylene glycols.

Examples of thixotropic agents which may be mentioned are pyrogenic silicic acids, polyamides, hydrogenated castor oil secondary products or polyvinyl chloride. According to the invention, thixotropic agents are used only to adjust the rheology of the adhesives and not to stabilize the dispersion of the polymer B in the polymer A.

As suitable catalysts for curing the adhesives according to the invention, it is possible to use any metal-organic compounds and amine catalysts which are known to promote silane polycondensation. Particularly suitable metal-organic compounds are especially tin and titanium compounds. Examples of preferred tin compounds are dibutyltin diacetate, dibutyltin dilaurate, dioctyltin maleate and tin carboxylates such as tin(II) octanoate or dibutyltin bis-acetoacetonate. Said tin catalysts can optionally be used in combination with amine catalysts such as aminosilanes or 1,4-diazabicyclo[2.2.2]octane. Examples of preferred titanium compounds are alkyl titanates such as diisobutyl bis-acetoacetic acid ethyl ester titanate. Amine catalysts which are particularly suitable for use on their own are those which have an especially high basic strength, such as amines with an amidine structure. Examples of preferred amine catalysts are therefore 1,8-diazabicyclo[5.4.0]undec-7-ene or 1,5-diazabicyclo[4.3.0]non-5-ene.

Brönstedt acids can also catalyse silane condensation. It is possible to use any acids which are compatible with the formulation in question. p-Toluenesulfonic acid, dodecylbenzenesulfonic acid or citric acid are mentioned here as examples.

Desiccants which may be mentioned in particular are alkoxysilyl compounds such as vinyltrimethoxysilane, methyltrimethoxysilane, i-butyltrimethoxysilane or hexa-decyltrimethoxysilane.

The known functional silanes are used as adhesion promoters, examples being aminosilanes of the aforementioned type, as well as N-aminoethyl-3-aminopropyltrimethoxysilane and/or N-aminoethyl-3-aminopropylmethyldimethoxysilane, epoxysilanes and/or mercaptosilanes. The adhesives according to the invention can be formulated as either one or two components.

Substrates coated or bonded with the adhesives according to the invention, especially after crosslinking of the adhesive with moisture, are also within the scope of the present invention.

The Examples which follow illustrate the present invention without implying a limitation.

### EXAMPLES

All percentages are by weight, unless indicated otherwise.

The ambient temperature of 23° C. prevailing at the time of experimentation is denoted as RT (room temperature).

The various polymers were processed in the following adhesive formulation for assessment of their adhesive properties:

| | Amount used in wt % |
|---|---|
| Polymer | 89.9 |
| Thixotropic agent (Cab-O-Sil ® TS 720) | 4.5 |
| Desiccant (Dynasylan ® VTMO) | 2.3 |
| Adhesion promoter (Dynasylan ® AMMO) | 3.0 |
| Catalyst (Lupragen ® N700) | 0.3 |

The formulation is prepared by adding the thixotropic agent (Cab-O-Sil® TS 720; Cabot) and the desiccant (Dynasylan® VTMO; Evonik AG) to the polymer and mixing the ingredients at 3000 rpm in a vacuum dissolver fitted with a wall scraper. Then the adhesion promoter (Dynasylan® AMMO; Evonik AG) is added and stirred in over 5 min at 1000 rpm. Lastly the catalyst (Lupragen® N700; BASF SE) is stirred in at 1000 rpm and the finished mixture is finally deaerated under vacuum.

### Determination of the Skin Forming Time

Using a doctor blade (200 μm) a film of the adhesive is applied to a glass plate previously cleaned with ethyl acetate, which is then immediately placed in the drying recorder. The needle is weighted with 10 g and travels a distance of 35 cm over a period of 24 hours.

The drying recorder is located in a climatic chamber at 23° C. and 50% rel. humidity.

The skin forming time is taken as the time after which the permanent trace of the needle disappears from the film.

The skin forming time was determined 1 day after preparation of the appropriate formulation.

### Determination of the Tensile Strength

The tensile strength is determined using singly overlapping test pieces made of beech with a 10 mm length of overlap. The requisite pieces of beech have the following dimensions: length=40 mm, width=20 mm, thickness=5 mm. The test pieces are compressed under a pressure of 0.7 N/mm² for 24 h at 23° C. and 50% rel. humidity and then stored for 7 days at 23° C. and 50% rel. humidity, then for 20 days at 40° C. and finally for one day at 23° C. and 50% rel. humidity.

The tensile strength is measured on a tensile tester at a speed of travel of 100 mm/min.

To illustrate the present invention, various adhesives were prepared using the formulation shown above. The polymers A used for this purpose were various alkoxysilane-modified polyether polyurethanes, either comprising no polymer B (Comparative Examples) or alternatively comprising a styrene-acrylonitrile copolymer (SAN) or a polyhydrazodicarbonamide polymer (PHD) as the polymer B. The polymers A were obtained by equimolar reaction of the appropriate polyether polyols with isocyanatopropyltrimethoxysilane. Because of the polymers B contained in the polymers A, the Examples according to the invention have a milky-white colour, whereas the Comparative Examples are clear to a transparent yellowish colour.

The molecular weight of each polymer A was calculated from the educts.

The functionality of the polymers A was calculated from the educts and refers to the total number of hydrolysable silane groups per polymer molecule.

The results obtained are shown in the Table below:

| | | Comp. | | | Comp. |
|---|---|---|---|---|---|
| | Ex. 1 | Ex. 1 | Ex. 2 | Ex. 3 | Ex. 2 |
| Calculated molecular | 3850 | 3850 | 5410 | 5410 | 5410 |
| weight of polymer A | | | | | |
| [g/mol] | | | | | |
| Calculated functionality | 9 | 9 | 9 | 9 | 9 |
| of polymer A | | | | | |
| Proportion of polymer B | 40 | 0 | 18 | 18 | 0 |
| in polymer A [wt %] | | | | | |
| Type of polymer B | SAN | — | SAN | PHD | — |
| Proportion of polymer B | 36 | — | 16 | 16 | — |
| in adhesive [wt %] | | | | | |
| Tensile strength [N/mm²] | 9.9 | 4.1 | 6.6 | 5.7 | 3.5 |

1. Moisture-curing adhesives comprising
a) at least one polymer A with at least one hydrolysable silane group and with at least one organic polymer B dispersed in the polymer A,
b) optionally other polymers with at least one hydrolysable silane group, and
c) optionally additives and auxiliary substances.

2. Adhesives according to claim 1 wherein the polymer A comprises at least 5% of organic polymer B.

3. Adhesives according to claim 1 wherein the polymer A comprises at least 10% of organic polymer B.

4. Adhesives according to claim 1 wherein the polymer A comprises at least 20% of organic polymer B.

5. Adhesives according to claim 1 wherein the organic polymers B are either reaction products of toluylene diisocyanate and hydrazine hydrate or copolymers of styrene and acrylonitrile.

6. Adhesives according to claim 1 wherein the polymer A comprises at least one urethane group.

7. Adhesives according to claim 1 whose tensile strength is at least 5 N/mm².

8. Adhesives according to claim 1 whose tensile strength is at least 6 N/mm².

9. Adhesives according to claim 1 whose tensile strength is at least 7 N/mm².

10. Adhesives according to claim 1 which do not comprise any external fillers.

11. Substrates coated or bonded with adhesives according to claim 1 and crosslinked adhesives formed therefrom.
